(19) United States
(12) Patent Application Publication
(10) Pub. No.: US 2011/0198437 A1
(43) Pub. Date: Aug. 18, 2011

(54) Helium rocket aerochute

(75) Inventor: Steven Roger Brandon, Tucson, AZ (US)

(73) Assignees: Lyle Marvin Tweet, Tucson, AZ (US); Lyle and Raosemary Tweet

(21) Appl. No.: 12/658,400

(22) Filed: Feb. 12, 2010

(51) Int. Cl. B64B 1/20

(52) U.S. Cl. 244/25

(57) ABSTRACT

This invention, the “aerochute,” creates a body suit full of helium and a flexible cloth wing above the user powered by a horizontally-orientated rocket jet pack that the user uses to “fly” through the air through the combination of the lift from the helium and the thrust from a rocket jet pack. The helium suit contains pockets of airtight helium that effectively reduce the weight of the individual, making him lighter and thus more susceptible to being lifted and thrust by the rocket jet pack. The wing is hollow and contains extra helium to give more lift to the user or “aeronaught.” The rocket jet pack gives thrust and direction to the individual flying the helium wing. Working in combination, the body suit with the packets of helium, the hollow wing, and the rocket jet pack combine to give the individual the ability to fly over extended distances at low altitudes.

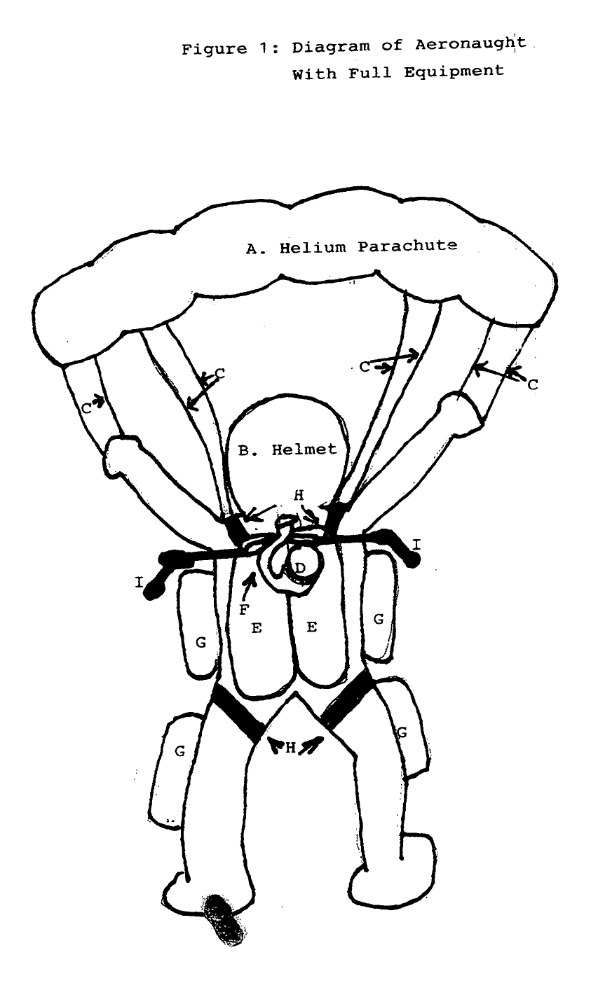

There is a need for a personal mobile airborne aircraft in many fields, including recreation and travel. This invention, the “aerochute,” solves that problem by providing users with a way to both elevate themselves off the ground and propel themselves forward through the air through the combination of helium floats and a rocket jet pack. Traditional “rocket packs” have relied upon the jet propulsion to both lift and thrust the individual forward. This traditional approach creates a heavy demand on the machine and user to lift and keep aloft the weight of the person and load as they are lifted and then thrust forward.

The helium suit and wing of this invention remove a large mass of the passenger's weight from the payload of the rocket thrust, allowing for less of a thrust which in turn gives the user greater control over the direction and distance of the craft while in flight. This, in turn, reduces the sizes and weights of the thrust packet needed to control and guide the unit.

The single wing goes across the top of the user like a rectangular parachute with the lengthwise portion running from left to right. The wing is one of two mechanisms the user can use to guide the personal aircraft. The wing may be used to guide the personal aircraft by pulling on either side to adjust the attitude and posture of the wing. The other mechanism that can be used by the user to guide the personal aircraft is to adjust the thrust angle of the rocket jet thrust via levers connected to the back rocket jet thrust mechanism. The user pulls a level up or down and then locks it into place, thereby locking the rocket jet thrusters into place on the back of the unit while in use.

The aerochute will have three main components: 1. The helium wing. 2. The rocket jet thrust packet. 3. The helium suit. The wing will serve to lift and guide the user while in flight. The rocket jet thrust packet will serve to propel the user up and forward across great distances, and it will give the user directional control of the flight. The helium suit will help augment the lift of the wing by further offsetting the body and other weight of the user.

I claim:

1. A device containing a rectangular helium-filled cloth-type parachute-like wing running left to right over the head of the user. The said helium wing will be attached several feet above the head of the user by cords that fasten to a body suit. This said body suit will allow the users to keep their hands free, unlike with a traditional directional parachute, while in flight. The helium wing will be hollow and filled with enough helium so as to give adequate lift off the ground to the user when used in combination with the helium suit, as discussed below. The said helium wing will allow the user to steer the flight by pulling on cords on either side of the said helium wing.

2. A helium suit with enclosed pockets of helium to help lift the weight of the user and accompanying gear. Said helium suit itself will not be filled with helium, but it will contain multiple balloon-like pockets that can be filled with helium and adjusted to compensate for the weight of the user and the user's gear. Additional pockets will carry compressed canisters of helium for use during and after the flight.

3. A typical rocket jet engine on the back of the user's helium suit of claim 2 will provide directional thrust while the user is in flight. The helium will provide the vertical lift and the rocket jet thrust pack will provide the horizontal thrust. The thrust will be guided by dual levers on either side of the user that will lock into place to hold the angle and attitude of the thrust for extended hands-free use.

4. Said rocket jet engine of claim 3 will be a fully self-contained rocket engine. The compressed liquid fuel will be stored in two or more canisters strapped to the back of the user, and the rocket thrust will point and burn in a direction perpendicular to the user's back, facing rearward. The fuel will be mixed in a combustion chamber and then the fuel will be burned and expelled from the back of the unit through thruster nozzles, providing thrust.

5. Said rocket jet engine of claim 3 will contain levers attached to the thrust exhaust unit. The levers will run from the back of the exhaust unit to the front of the user's hands, giving the user the ability to manually control the direction of the thrust. These thrust control levers will be able to lock into position, giving the user the ability to keep their hands free while in flight. Said rocket engine of claim 3 is not described in more detail because it is a standard-type rocket engine a part from yet incorporated into this patent. Because the rocket thruster will be of standard and public design in the public domain, the exact specifications are not necessary for the issuance of this utility design patent and hence are not be discussed at length here. The specific type and formulation of the rocket engines involved are secondary and subservient to the essential claims being patented in this application.
